(19) United States
(12) Patent Application Publication
(10) Pub. No.: US 2024/0412237 A1
(43) Pub. Date: Dec. 12, 2024

(54) CUSTOMIZABLE AND GRANULAR ANALYTICS TOOL FOR SHARED CONTENT ITEMS BASED ON CUSTOM LINKS

(71) Applicant: Dropbox, Inc, San Francisco, CA (US)

(72) Inventors: Timothy Olds, Long Beach, CA (US); Kenneth Chan, Millbrae, CA (US); Zafarali Bootwala, Torrance, CA (US)

(21) Appl. No.: 18/332,959

(22) Filed: Jun. 12, 2023

(51) Int. Cl. G06Q 30/0201

(52) U.S. Cl. CPC G06Q 30/0201

(57) ABSTRACT

Systems or methods for generating a plurality of different custom links that have different viewing options for viewing the same shared content item in customized content item players and displaying engagement analytics for how viewers are viewing shared content items, such as videos, are disclosed. A custom link to view the shared content item is generated in association with settings that are customized by an administrator. Once the custom link is accessed, a customized content item player is generated based on the settings. Once the content item is being played in a customized content item player, the engagement analytics are populated in real-time in a graphical display. The different engagement levels and graphical representations of segments of viewing are distinguished based on the engagement levels.

### BACKGROUND

Computing devices provide various ways for users to interact with digital content. Additionally, users have many different software tools to perform a variety of different kinds of analytics of engagement with how users interact with the digital content. For example, users view and interact with different kinds of videos for various purposes with respective analytics being recorded for later assessment. When the viewing experience and analytics monitoring are standardized, it limits the ability to personalize and customize how the users interact with the digital content.

### BRIEF DESCRIPTION OF THE DRAWINGS

To easily identify the discussion of any particular element or act, the most significant digit or digits in a reference number refer to the figure number in which that element is first introduced. The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a content management system and client devices in accordance with some aspects of the present technology.

FIG. 2 illustrates a method for generating a custom link associated with a customized player dedicated to presenting a content item in accordance with some aspects of the present technology.

FIG. 3 illustrates a method for assigning an engagement level associated with how engaged a viewer is in viewing the content item during a period of time in accordance with some aspects of the present technology.

FIG. 4 illustrates a method for generating segments that visualize the engagement level for segments of viewing in accordance with some aspects of the present technology.

FIG. 5 illustrates an example graphical display showing segments associated with a session for a custom link of a first content item in accordance with some aspects of the present technology.

FIG. 6A illustrates an example graphical display showing segments associated with a session for viewing a content item after a first period of time has passed in accordance with some aspects of the present technology.

FIG. 6B illustrates an example graphical display showing segments associated with the session for the content item after a second period of time has passed in accordance with some aspects of the present technology.

FIG. 7A illustrates an example settings configuration panel that includes various options for configuring a custom link for viewing a content item in accordance with some aspects of the present technology.

FIG. 7B illustrates an example graphical display of a list of generated custom links associated with a content item in accordance with some aspects of the present technology.

FIG. 8 illustrates an example window associated with a custom link and associated customized content item player of a content item in accordance with some aspects of the present technology.

FIG. 9A illustrates example event stream data associated with events such as when a content item is played, paused, seeked forward, or seeked backwards in accordance with some aspects of the present technology.

FIG. 9B illustrates processed event data in a database table based on processing of the event stream data and has start times and updated end times for relevant events in FIG. 9A in accordance with some aspects of the present technology.

FIG. 10 illustrates an example graphical display of comparative statistics associated with how engaged viewers are in viewing the content item in accordance with some aspects of the present technology.

FIG. 11 illustrates an example computing system in accordance with some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The present technology addresses the need in the art for providing additional flexibility around sharing a content item. Typically, when sharing a content item, a link is used to give access to the content item. Different users might be given differentiated access (read-only, edit, etc.), but that is the extent of differentiation or customization that can be provided when sharing the content item. Accordingly, there is a need to provide greater customization for recipients of content items. This can be especially true for video content items or presentations but is applicable to all content items.

The present technology provides functionality for a sharing user account to configure a viewing experience for a recipient receiving access to a content item. The configurations are associated with a link sent to a recipient such that any recipient that receives the link can be provided with a viewing experience for the content item that is customized for that link. In some embodiments, the configurations associated with the link are received by the recipient user device along with data for the shared content item, and the configurations are effective to configure a player to provide a viewing experience consistent with the configurations. Accordingly, the shared content item can be viewed on a player on a viewer-by-viewer basis when each viewer receives a specific custom link associated with custom configurations.

The present technology also enables greater granularity in understanding and viewing engagement data associated with how viewers are engaged with the content item. The engagement data can be captured for any interval of time, which can facilitate the sharing user recreating the viewing experience for the viewing users and learning deep insights about the viewing of the content items. The engagement data may include any type of data associated with metrics that distinguish different types of engagement associated with how the user is experiencing the content item at the customized content item player. The engagement data may be analyzed and visualized as engagement analytics in a graphical display.

Contrasting a use case of an investor receiving a pitch deck with an employee receiving a human resources video can illustrate some of the benefits of the present technology. An entrepreneur sharing a pitch deck with an investor to raise capital might want to put fewer restrictions on how the pitch deck is viewed but might seek detailed information about the investor's review of the pitch deck. The entrepreneur would not want to encumber the investor's ability to flip through slides or segments of a video quickly, but the entrepreneur will want to know what parts of the content item the investor took time to carefully consider and what parts might have been less interesting.

In contrast, a human resources professional might share a content item that is required viewing, and therefore the human resources professional might want to configure a player of the content item to prohibit skipping or fast forwarding. However, the human resources professional may be less interested in engagement data and might only want to know that the recipient of the content item finished viewing the content item. Accordingly, the present technology satisfies a need for a customizable tool that not only provides access to granular engagement data for how viewers are viewing shared content items but also customization options that provide different ways of configuring a customized content item player to control the viewing the same content item or different content items to serve different needs.

With respect to configuring how the content item is viewed, most settings for playing a content item may be configured once. However, sometimes there are different configuration needs for playing the content item. For example, for a video that is a homework assignment, a teacher may set certain viewing restrictions, such as removing an ability to skip forward, for students that need to watch the video. However, for the same video, the teacher may want to send the video for their peers to watch and review and may not want to add any restrictions.

The present technology permits issuing a plurality of different custom links which are links associated with custom configurations for a customized content item player to provide different viewing options for viewing the content item. A custom link to view the shared content item may be generated in association with settings that are customized by an administrator. Once generated, the custom link may be accessed, with or without passing authentication requirements depending on the settings. Once the custom link is accessed, a customized content item player is generated based on the settings. For example, the customized content item player may not allow forward seeking or pausing the content item when a window displaying the customized content item player is a background window or an inactive window. The customization options allow a user account to set viewing options differently for different users, giving more control over how the content item is viewed in certain circumstances while restricting the control in others.

The present technology also provides a granular and visual representation of engagement data showing changes in the engagement levels of a particular user experiencing the content item. Most representations of engagement provide an overview of how all viewers view a content item. However, the present technology can visualize the engagement data in a more detailed manner that distinguishes between different sessions of viewing of a same viewer or different viewers. Each session of viewing is a period of time starting from when a customized content item player is launched in an application through the custom link to when the application is closed. The period of time may include periods of play, pauses, seeking back, muting, etc. at the customized content item player in the application. The custom link may be engaged more than once and each time the custom link is engaged, a new application or window with a customized content item player with the same set of settings may be launched, as dictated by the custom link. Consequently, the customized content item player may be associated with a new session of viewing. The engagement analytics visualized allows a sharing user account to retrace a full viewing journey for each session of each viewer that viewed the content item and how engaged the viewer(s) was throughout the viewings.

For example, once the content item is being played in the customized content item player, the engagement data may be captured and analyzed, and the resulting engagement analytics may be visualized as segments in real-time in a graphical display associated with the administrator. The segments may distinguish between different engagement levels, such as a distracted engagement level or an attentive engagement level. The engagement levels may be determined based on how the content item is being viewed with respect to different engagement events, such as whether the viewer has changed from viewing in full screen to viewing a smaller screen, or whether the customized content item player has been muted or has increased in volume.

The present technology thus addresses current problems in the art by making it easier to generate customized ways to view a content item without changing any properties of the content item, allowing for a simple way to share customized experiences of viewing the same content item. In this way, the present technology reduces each of the multiple action steps for providing various ways to view a particular content item, which requires fewer burdens on both a computing system (by needing to navigate to and render fewer interfaces) and a user (by reducing the number of steps they need to perform). The present technology also addresses current problems in the art by providing a comprehensive summary of granular views of engagement analytics throughout an entire session for every viewer. As such, the present technology enables the interplay of analytics with the ability to control a viewer's experience interacting with the content.

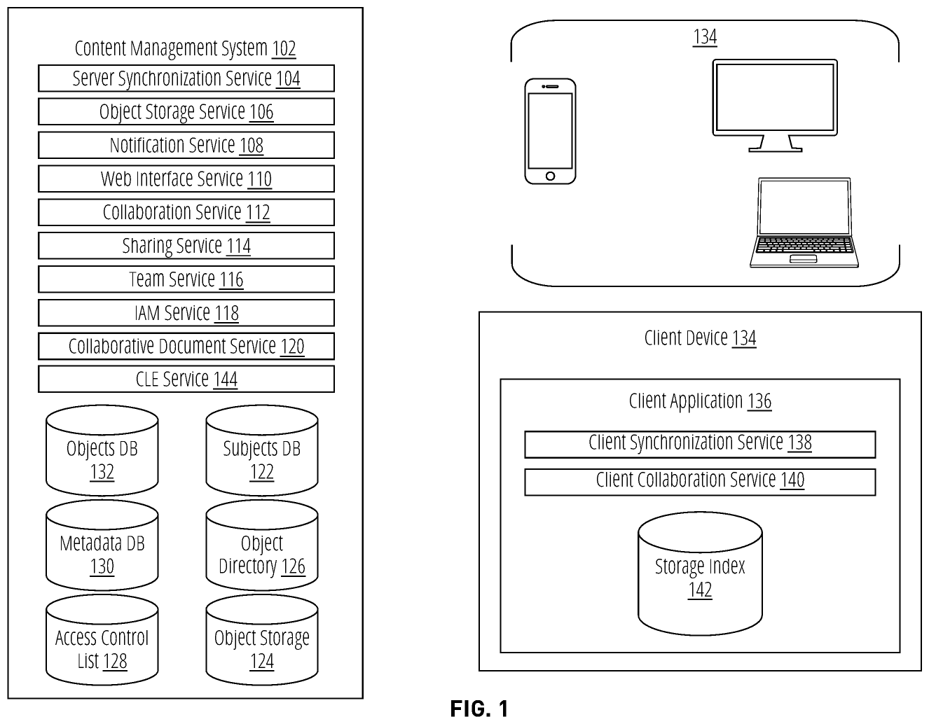

In some embodiments, the disclosed technology is deployed in the context of a content management system having object synchronization capabilities and collaboration features, among others. An example system configuration 100 is shown in FIG. 1, which depicts content management system 102 interacting with client device 134.

### Accounts

Content management system 102 can store objects in association with accounts, as well as perform a variety of object management tasks, such as retrieve, modify, browse, and/or share the object(s). Furthermore, content management system 102 can enable an account to access object(s) from multiple client devices.

Content management system 102 supports a plurality of accounts. A subject (user, group, team, company, etc.) can create an account with content management system, and account details can be stored in subject database 122. Subject database 122 can identify a registered subject by a subject ID, and store profile information for registered subjects in association with the subject ID. In some cases, profile information for registered subjects includes a subject name and/or email address. Subject database 122 can include account management information, such as account type (e.g. various tiers of free or paid accounts), storage space allocated, storage space used, client devices 134 having a registered content management client application 136 resident thereon, security settings, personal configuration settings, etc. In some embodiments, some information associated with an account may not be directly stored, and rather this information can be derived. For example, storage space used might be explicitly stored, or it can be calculated when needed.

In some embodiments, subject database 122 need not store complete information associated with an account for a subject. Some portion of information associated with an account for a subject can also be stored in another database of content management system 102 such as metadata database 130, or in a database external to content management system 102.

Subject database 122 can store groups of accounts associated with a subject. Groups can have permissions based on group permissions statements and/or access control lists, and members of the groups can inherit the permissions. For example, a marketing group can have access to one set of objects while an engineering group can have access to another set of objects. An administrator group can modify groups, modify subject accounts, etc. Groups are also subjects identified by subject ID.

In some embodiments, subject database 122 can be broken into a plurality of tables, indexes and other data structures.

### Object Storage

A feature of content management system 102 is the storage of objects, which can be stored in object storage 124. An object generally is any entity that can be recorded in a file system. Objects can be any object including digital data such as documents, collaboration objects, text files, audio files, image files, video files, webpages, executable files, binary files, object directories, folders, zip files, playlists, albums, symlinks, cloud docs, mounts, placeholder objects referencing other objects in content management system 102 or in other content management systems, etc.

In some embodiments, objects can be grouped into a collection, which can refer to a folder including a plurality of objects, or a plurality of objects that are related or grouped by a common attribute.

In some embodiments, object storage 124 is combined with other types of storage or databases to handle specific functions. Object storage 124 can store objects, while metadata regarding the objects can be stored in metadata database 130. Likewise, data regarding where an object is stored in object storage 124 can be stored in object directory 126. Additionally, data regarding changes, access, etc. can be stored in objects database 132. Objects database 132 can also include a subject account identifier that identifies the subject IDs that have access to the object.

In some embodiments, objects database 132 can be broken into a plurality of tables, indexes and other data structures.

Each of the various storages/databases such as object storage 124, object directory 126, objects database 132, and metadata database 130 can be comprised of more than one such storage or database and can be distributed over many devices and locations. Other configurations are also possible. For example, data from object storage 124, object directory 126, objects database 132, and/or metadata database 130 may be combined into one or more object storages or databases or further segmented into additional object storages or databases. Thus, content management system 102 may include more or less storages and/or databases than shown in FIG. 1.

In some embodiments, object storage 124 is associated with at least one object storage service 106, which includes software or other processor executable instructions for managing the storage of objects including, but not limited to, receiving objects for storage, preparing objects for storage, selecting a storage location for the object, retrieving objects from storage, etc. In some embodiments, object storage service 106 can divide an object into smaller chunks for storage at object storage 124. The location of each chunk making up an object can be recorded in object directory 126. Object directory 126 can include a content entry for each object stored in object storage 124. The content entry can be associated with an object ID, which uniquely identifies an object.

In some embodiments, each object and each chunk of an object can also be identified from a deterministic hash function. This method of identifying an object and chunks of objects can ensure that object duplicates are recognized as such since the deterministic hash function will output the same hash for every copy of the same object, but will output a different hash for a different object. Using this methodology, object storage service 106 can output a unique hash for each different version of an object.

Object storage service 106 can also designate or record a parent of an object or a content path for an object in objects database 132. The content path can include the name of the object and/or folder hierarchy associated with the object. For example, the content path can include a folder or path of folders in which the object is stored in a local file system on a client device. In some embodiments, object database might only store a direct ancestor or direct child of any object, which allows a full path for an object to be derived, and can be more efficient than storing the whole path for an object.

While objects are stored in object storage 124 in blocks and may not be stored under a tree like directory structure, such directory structure is a comfortable navigation structure for subjects viewing objects. Object storage service 106 can define or record a content path for an object wherein the “root” node of a directory structure can be any directory with specific access privileges assigned to it, as opposed to a directory that inherits access privileges from another directory.

In some embodiments a root directory can be mounted underneath another root directory to give the appearance of a single directory structure. This can occur when an account has access to a plurality of root directories. As addressed above, the directory structure is merely a comfortable navigation structure for subjects viewing objects, but does not correlate to storage locations of objects in object storage 124.

While the directory structure in which an account views objects does not correlate to storage locations of the objects at content management system 102, the directory structure can correlate to storage locations of the objects on client device 134 depending on the file system used by client device 134.

As addressed above, a content entry in object directory 126 can also include the location of each chunk making up an object. More specifically, the content entry can include content pointers that identify the location in object storage 124 of the chunks that make up the object.

Object storage service 106 can decrease the amount of storage space required by identifying duplicate objects or duplicate blocks that make up an object or versions of an object. Instead of storing multiple copies, object storage 124 can store a single copy of the object or block of the object, and object directory 126 can include a pointer or other mechanism to link the duplicates to the single copy.

Object storage service 106 can also store metadata describing objects, object types, folders, file path, and/or the relationship of objects to various accounts, collections, or groups in metadata database 130, in association with the object ID of the object.

Object storage service 106 can also store a log of data regarding changes, access, etc. in objects database 132. Objects database 132 can include the object ID of the object and can optionally include a description of the change or access action along with a time stamp or version number and any other relevant data. Objects database 132 can also include pointers to blocks affected by the change or object access. Object storage service 106 can also provide the ability to undo operations, by using an object version control mechanism that tracks changes to objects, different versions of objects (including diverging version trees), and a change history that can be acquired from objects database 132.

### Object Synchronization

Another feature of content management system 102 is synchronization of objects with at least one client device 134. Client devices 134 can take different forms and have different capabilities. For example, client device 134 can be a computing device having a local file system accessible by multiple applications resident thereon. Client device 134 can be a computing device wherein objects are only accessible to a specific application or by permission given by the specific application, and the objects are typically stored either in an application specific space or in the cloud. Client device 134 can be any client device accessing content management system 102 via a web browser and accessing objects via a web interface. While example client device 134 is depicted in form factors such as a laptop, mobile device, or web browser, it should be understood that the descriptions thereof are not limited to devices of these example form factors. For example a mobile device might have a local file system accessible by multiple applications resident thereon, or might access content management system 102 via a web browser. As such, the form factor should not be considered limiting when considering client device's 134 capabilities. One or more functions described herein with respect to client device 134 may or may not be available on every client device depending on the specific capabilities of the device-the file access model being one such capability.

In many embodiments, client devices 134 are associated with an account of content management system 102, but in some embodiments client device 134 can access content using shared links and do not require an account.

As noted above, some client devices can access content management system 102 using a web browser. However, client devices can also access content management system 102 using client application 136 stored and running on client device 134. Client application 136 can include a client synchronization service 138.

Client synchronization service 138 can be in communication with server synchronization service 104 to synchronize changes to objects between client device 134 and content management system 102.

Client device 134 can synchronize content with content management system 102 via client synchronization service 138. The synchronization can be platform agnostic. That is, content can be synchronized across multiple client devices of varying types, capabilities, operating systems, etc. Client synchronization service 138 can synchronize any changes (e.g., new, deleted, modified, copied, or moved objects) to objects in a designated location of a file system of client device 134.

Objects can be synchronized from client device 134 to content management system 102, and vice versa. In embodiments wherein synchronization is from client device 134 to content management system 102, a subject can manipulate objects directly from the file system of client device 134, while client synchronization service 138 can monitor directory on client device 134 for changes to files within the monitored folders.

When client synchronization service 138 detects a write, move, copy, or delete of content in a directory that it monitors, client synchronization service 138 can synchronize the changes to object storage service 106. In some embodiments, client synchronization service 138 can perform some functions of object storage service 106 including functions addressed above such as dividing the object into blocks, hashing the object to generate a unique identifier, etc. Client synchronization service 138 can index content within client storage index 142 and save the result in client storage index 142. Indexing can include storing paths plus the object identifier, and a unique identifier for each object. In some embodiments, client synchronization service 138 learns the object identifier from server synchronization service 104, and learns the unique client identifier from the operating system of client device 134.

Client synchronization service 138 can use storage index 142 to facilitate the synchronization of at least a portion of the objects within client storage with objects associated with a subject account on content management system 102. For example, client synchronization service 138 can compare storage index 142 with content management system 102 and detect differences between content on client storage and content associated with a subject account on content management system 102. Client synchronization service 138 can then attempt to reconcile differences by uploading, downloading, modifying, and deleting content on client storage as appropriate. Object storage service 106 can store the changed or new block for the object and update objects database 132, metadata database 130, object directory 126, object storage 124, subject database 122, etc. as appropriate.

When synchronizing from content management system 102 to client device 134, data regarding a mount, modification, addition, deletion, move of an object recorded in objects database 132 can trigger a notification to be sent to client device 134 using notification service 108. When client device 134 is informed of the change, client device 134 can make a request for changes listed in objects database 132 since the last synchronization point known to the client device. When client device 134 determines that it is out of synchronization with content management system 102, client synchronization service 138 requests object blocks including the changes, and updates its local copy of the changed objects.

In some embodiments, storage index 142 stores tree data structures wherein one tree reflects the latest representation of a directory according to server synchronization service 104, while another tree reflects the latest representation of the directory according to client synchronization service 138. Client synchronization service 138 can work to ensure that the tree structures match by requesting data from server synchronization service 104 or committing changes on client device 134 to content management system 102.

Sometimes client device 134 might not have a network connection available. In this scenario, client synchronization service 138 can monitor the linked collection for object changes and queue those changes for later synchronization to content management system 102 when a network connection is available. Similarly, a subject can manually start, stop, pause, or resume synchronization with content management system 102.

Client synchronization service 138 can synchronize all content associated with a particular subject account on content management system 102. Alternatively, client synchronization service 138 can selectively synchronize some of the objects associated with the particular subject account on content management system 102. Selectively synchronizing only some of the objects can preserve space on client device 134 and save bandwidth.

In some embodiments, client synchronization service 138 selectively stores a portion of the objects associated with the particular subject account and stores placeholder objects in client storage for the remainder portion of the objects. For example, client synchronization service 138 can store a placeholder object that has the same filename, path, extension, metadata, of its respective complete object on content management system 102, but lacking the data of the complete object. The placeholder object can be a few bytes or less in size while the respective complete object might be significantly larger. After client device 134 attempts to access the object, client synchronization service 138 can retrieve the data of the object from content management system 102 and provide the complete object to client device 134. This approach can provide significant space and bandwidth savings while still providing full access to a subject's objects on content management system 102.

While the synchronization embodiments addressed above referred to client device 134 and a server of content management system 102, it should be appreciated by those of ordinary skill in the art that a user account can have any number of client devices 134 all synchronizing objects with content management system 102, such that changes to an object on any one client device 134 can propagate to other client devices 134 through their respective synchronization with content management system 102.

### Collaboration Features

Another feature of content management system 102 is to facilitate collaboration between subjects. Collaboration features include object sharing, commenting on objects, co-working on objects in real time, instant messaging, providing presence and “seen” state information regarding objects, etc.

### Sharing

Content management system 102 can manage sharing objects via sharing service 114. Sharing an object by providing a link to the object can include making the object accessible from any computing device in network communication with content management system 102. However, in some embodiments a link can be associated with access restrictions enforced by content management system 102 and Identity and Access Management service (IAM service) 118. Sharing content can also include linking content using sharing service 114 to share content within content management system 102 with at least one additional subject account (in addition to the original subject account associated with the object) so that each subject account has access to the object. The additional subject account can gain access to the content by accepting the content, which will then be accessible through either web interface service 110 or directly from within the directory structure associated with their account on client device 134. The sharing can be performed in a platform agnostic manner. That is, the content can be shared across multiple client devices 134 of varying type, capabilities, operating systems, etc. The content can also be shared across varying types of subject accounts.

To share an object within content management system 102, sharing service 114 can add associate a subject ID of a team or of one or more subject accounts with a content item in objects database 132 associated with the object, thus granting the added subject account(s) access to the object. Sharing service 114 can also remove subject IDs from being permitted to access a content item in objects database 132 to restrict a subject account's access to the object. Sharing service 114 can record object identifiers, subject identifiers given access to an object, and access levels in objects database 132. For example, in some embodiments, subject identifiers associated with a single content item can specify different permissions for respective subject identifiers with respect to the associated object.

In some embodiments, content management system 102 can include an access control list 128 which includes a description of complete access rights pertaining to a respective object. An access control list for any respective object in content management system can be derived from objects database 132. In some embodiments, it is not desirable to maintain a persistent access control list 128 for a respective object, as an access control list 128 for a respective object can be derived when needed. In some embodiments, objects can inherit access rights from another object such as ancestor objects.

To share objects outside of content management system 102, sharing service 114 can generate a custom network address, such as a uniform resource locator (URL), which allows any web browser to access the object or collection in content management system 102 without any authentication. To accomplish this, sharing service 114 can include content identification data in the generated URL, which can later be used to properly identify and return the requested object. For example, sharing service 114 can include a token identifying an object ID and optionally a subject ID in the generated URL. Upon selection of the URL, the content identification data included in the URL can be transmitted to content management system 102, which can use the received content identification data to identify the appropriate object and return the object.

In addition to generating the URL, sharing service 114 can also be configured to record in objects database 132 that a URL to the object has been created. In some embodiments, an entry into objects database 132 associated with an object can include a URL flag indicating whether a URL to the object has been created. For example, the URL flag can be a Boolean value initially set to 0 or false to indicate that a URL to the object has not been created. Sharing service 114 can change the value of the flag to 1 or true after generating a URL to the object.

In some embodiments, sharing service 114 can associate a set of permissions to a URL for an object. For example, if a subject attempts to access the object via the URL, sharing service 114 can provide a limited set of permissions for the object. Examples of limited permissions include restrictions that the subject cannot download the object, save the object, copy the object, modify the object, etc. In some embodiments, limited permissions include restrictions that only permit an object to be accessed from with a specified domain,, such as from within a corporate network domain, or by accounts associated with a specified domain, e.g., accounts associated with a company account (e.g., @acme.com).

In some embodiments, sharing service 114 can also be configured to deactivate a generated URL. For example, each entry into objects database 132 can also include a URL active flag indicating whether the content should be returned in response to a request from the generated URL. For example, sharing service 114 can only return an object requested by a generated link if the URL active flag is set to 1 or true. Thus, access to an object for which a URL has been generated can be easily restricted by changing the value of the URL active flag. This allows a subject to restrict access to the shared object without having to move the object or delete the generated URL. Likewise, sharing service 114 can reactivate the URL by again changing the value of the URL active flag to 1 or true. A subject can thus easily restore access to the object without the need to generate a new URL.

In some embodiments, content management system 102 can designate a URL for uploading an object. For example, a first subject with a subject account can request such a URL, provide the URL to a contributing subject and the contributing subject can upload an object to the first subject's subject account using the URL.

### Team Service

In some embodiments content management system 102 includes team service 116. Team service 116 can provide functionality for creating and managing defined teams of subject accounts. Teams can be created for a company, with sub-teams (e.g., business units, or project teams, etc.), and subject accounts assigned to teams and sub-teams, or teams can be created for any defined group of subject accounts. Team service 116 can provide a common shared space for the team, private subject account folders, and access limited shared folders. Team service 116 can also provide a management interface for an administrator to manage collections and objects within team, and can manage subject accounts that are associated with the team. Teams, sub-teams, subject accounts are all given a subject identifier in subject database 122, and the membership to teams by subject accounts is also recorded in subject database 122.

### IAM (Identity and Access Management) Service

In some embodiments, content management system 102 includes IAM service 118. IAM service 118 can authenticate a subject account. For subject accounts with multiple levels of rights (e.g. a subject account with subject rights and administrator rights) IAM service 118 can also facilitate explicit privilege escalation to avoid unintentional actions by administrators.

### Object Access

Object storage service 106 can receive a token from client application 136 that follows a request to access an object and can return the capabilities permitted to the subject account.

### Presence and Seen State

In some embodiments, content management system 102 can provide information about how subjects with which an object is shared are interacting or have interacted with the object. In some embodiments, content management system 102 can report that a subject with which an object is shared is currently viewing the object. For example, client collaboration service 140 can notify notification service 108 when client device 134 is accessing the object. Notification service 108 can then notify all client devices of other subjects having access to the same object of the presence of the subject of client device 134 with respect to the object.

In some embodiments, content management system 102 can report a history of subject interaction with a shared object. Collaboration service 112 can query data sources such as metadata database 130 and objects database 132 to determine that a subject has saved the object, that a subject has yet to view the object, etc., and disseminate this status information using notification service 108 to other subjects so that they can know who currently is or has viewed or modified the object.

Collaboration service 112 can facilitate comments associated with content, even if an object does not natively support commenting functionality. Such comments can be stored in metadata database 130.

Collaboration service 112 can originate and transmit notifications for subjects. For example, a subject can mention another subject in a comment and collaboration service 112 can send a notification to that subject letting them know that they have been mentioned in the comment. Various other object events can trigger notifications, including deleting an object, sharing an object, etc.

Collaboration service 112 can also provide a messaging platform whereby subjects can send and receive instant messages, voice calls, emails, etc.

### Collaboration Objects

In some embodiments content management service can also include collaborative document service 120 which can provide an interactive object collaboration platform whereby subjects can simultaneously create collaboration objects, comment in the collaboration objects, and manage tasks within the collaboration objects. Collaboration objects can be files that subjects can create and edit using a collaboration object editor, and can contain collaboration object elements. Collaboration object elements may include a collaboration object identifier, one or more author identifiers, collaboration object text, collaboration object attributes, interaction information, comments, sharing subjects, etc. Collaboration object elements can be stored as database entities, which allows for searching and retrieving the collaboration objects. Multiple subjects may access, view, edit, and collaborate on collaboration objects at the same time or at different times. In some embodiments this can be managed by requiring two subjects access an object through a web interface and there they can work on the same copy of the object at the same time.

### Collaboration Companion Interface

In some embodiments client collaboration service 140 can provide a native application companion interface for the purpose of displaying information relevant to an object being presented on client device 134. In embodiments wherein an object is accessed by a native application stored and executed on client device 134, where the object is in a designated location of the file system of client device 134 such that the object is managed by client application 136, the native application may not provide any native way to display the above addressed collaboration data. In such embodiments, client collaboration service 140 can detect that a subject has opened an object, and can provide an overlay with additional information for the object, such as collaboration data. For example, the additional information can include comments for the object, status of the object, activity of other subjects previously or currently viewing the object. Such an overlay can warn a subject that changes might be lost because another subject is currently editing the object.

In some embodiments, one or more of the services or storages/databases discussed above can be accessed using public or private application programming interfaces.

Certain software applications can access object storage 124 via an application programming interface (API) on behalf of a subject. For example, a software package such as an application running on client device 134, can programmatically make API calls directly to content management system 102 when a subject provides authentication credentials, to read, write, create, delete, share, or otherwise manipulate content.

A subject can view or manipulate content stored in a subject account via a web interface generated and served by web interface service 110. For example, the subject can navigate in a web browser to a web address provided by content management system 102. Changes or updates to content in the object storage 124 made through the web interface, such as uploading a new version of an object, can be propagated back to other client devices associated with the subject's account. For example, multiple client devices, each with their own client software, can be associated with a single account and objects in the account can be synchronized between each of the multiple client devices.

Client device 134 can connect to content management system 102 on behalf of a subject. A subject can directly interact with client device 134, for example when client device 134 is a desktop or laptop computer, phone, television, internet-of-things device, etc. Alternatively or additionally, client device 134 can act on behalf of the subject without the subject having physical access to client device 134, for example when client device 134 is a server.

Some features of client device 134 are enabled by an application installed on client device 134. In some embodiments, the application can include a content management system specific component. For example, the content management system specific component can be a stand-alone client application 136, one or more application plug-ins, and/or a browser extension. However, the subject can also interact with content management system 102 via a third-party application, such as a web browser, that resides on client device 134 and is configured to communicate with content management system 102. In various implementations, the client application 136 can present a subject interface (UI) for a subject to interact with content management system 102. For example, the subject can interact with the content management system 102 via a file system explorer integrated with the file system or via a webpage displayed using a web browser application.

In some embodiments, client application 136 can be configured to manage and synchronize content for more than one account of content management system 102. In such embodiments client application 136 can remain logged into multiple accounts and provide normal services for the multiple accounts. In some embodiments, each account can appear as folder in a file system, and all objects within that folder can be synchronized with content management system 102. In some embodiments, client application 136 can include a selector to choose one of the multiple accounts to be the primary account or default account.

### Third Party Services

In some embodiments content management system 102 can include functionality to interface with one or more third party services such as workspace services, email services, task services, etc. In such embodiments, content management system 102 can be provided with login credentials for a subject account at the third party service to interact with the third party service to bring functionality or data from those third party services into various subject interfaces provided by content management system 102.

While content management system 102 is presented with specific components, it should be understood by one skilled in the art, that the architectural system configuration 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system 100 is presented with specific components, it should be understood by one skilled in the art, that the architectural system configuration 100 is simply one possible configuration and that other configurations with more or fewer components are possible.

### Custom Link and Content Item Player Engagement (CLE) Service

In some embodiments, content management system 102 can include a custom link and customized content item player engagement (CLE) service 144 that provides a functionality to capture engagement data indicative of how viewers are viewing content items, such as videos, as well as provide customization options that allow for different ways of viewing the content item or different content items in serving different needs. The engagement data may be analyzed to generate the engagement analytics. In such embodiments, CLE service 144 may provide a visualization of the engagement analytics that retrace a full journey of views of the content item and provides a visual representation of how engaged the viewer was throughout the viewing. CLE service 144 may provide customization options that allow a user to set viewing options differently for different audiences, giving more control over how the content item is viewed in certain circumstances while restricting the control in others.

CLE service 144 may generate a plurality of custom links that include custom configurations for a content item player to provide different viewing options for viewing the same content item. An administrator can generate a new custom link for viewing the content item, and each link will generate a new customized content item player according to the custom configurations specified by the custom link. In some cases, the customized content item player may be generated in a new browser once the custom link is engaged. As the content item plays in the customized content item player, CLE service 144 may cause to display real-time engagement analytics in a graphical format for the administrator. The engagement data may be analyzed to generate the engagement analytics that may be used in forming visualizations of segments that differentiate between engagement levels, such as lower and attentive engagement levels for example, based on how the content item is being viewed. The engagement data may include various engagement events, such as whether the viewer has changed from viewing in full screen mode to a more minimized window or whether the customized content item player has been muted, which may change within a session and be used to generated segments.

CLE service 144 may also have the ability to efficiently store event data through the generation of a range event. A range event is a back-end event parameter that is used to change event stream data to processed event data. The event stream data refers to a stream of real-time event data indicating events such as when a content item is being played, paused, seeked forward, or seeked backwards at the customized content item player and the processed event data refers to processed event stream data that has start times and updated end times for relevant events. Specifically, the range event is an event parameter associated with a user continuously (e.g., without interruption) playing a content item over a particular time range defined by a start time and an end time. In some cases, the range event may record the start time as the first time and null as the end time when the range event is initiated. When the content item is paused or no longer played in the same manner, the end time may be updated with a time, and a baseline segment is generated. The use of the range events helps with minimizing the amount of storage necessary in recording the event data.

A baseline segment, associated with an entirety of uninterrupted play period of the content item, may include one or more sub-segments that may be triggered when there is an engagement event that amounts to a different engagement level. The sub-segment are segments of viewing that are associated with an engagement level that is distinct from neighboring segments of viewing. In other words, the baseline segment is associated with an entire uninterrupted period of time of viewing the content item and within that baseline segment, there may be one or more sub-segments that are associated with a respective engagement level indicating how engaged the viewer is in experiencing the content item at the customized content item player.

How a user is choosing to experience the content item may include settings such as playing with sound, playing muted, setting the customized content item player in the foreground, setting the customized content item player in the background, setting the playback speed to a certain speed, having forward scrubbing control engaged, and having backward scrubbing control engaged. As mentioned previously, the customized content item player may be customized to allow for different ways that a user may be allowed to experience viewing the content item. Therefore, if the viewer is not allowed to mute their customized content item player, muting would not be considered an engagement event. An engagement event is a user behavior that changes the content item viewing experience and indicates a change in the user's engagement (e.g., muting, moving the customized content item player to the background, etc.). However, if the viewer is allowed to mute their customized content item player, if the viewer changes to mute their customized content item player while in the middle of playing the content item, the engagement event may change the engagement level and trigger a sub-segment. When referencing segments generally, that may include a baseline segment and/or sub-segments associated with the baseline segment.

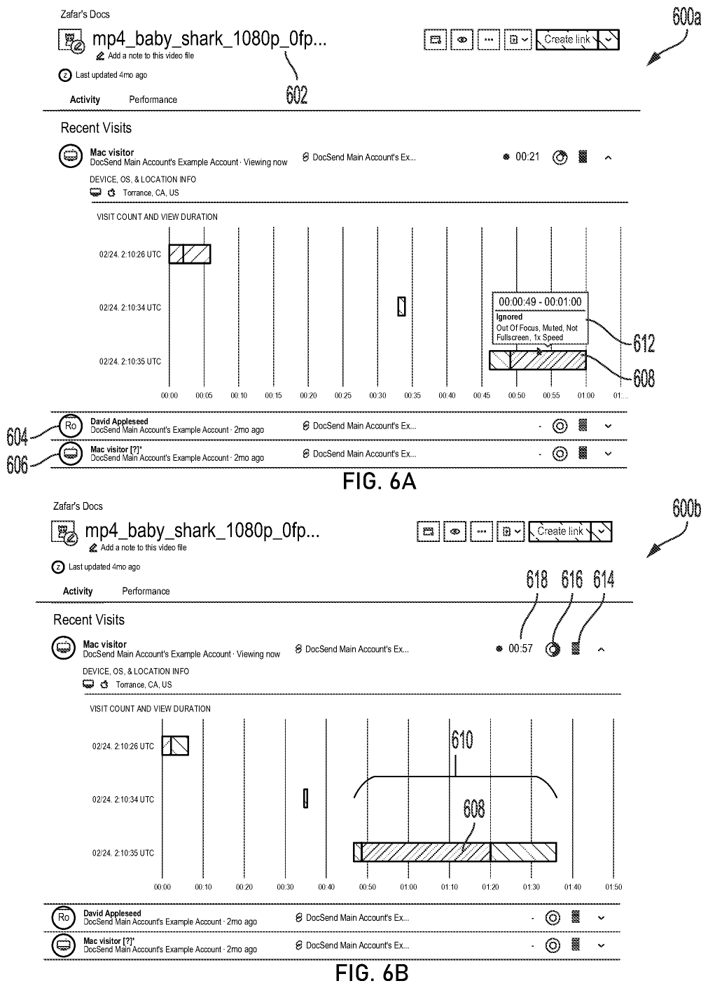

An example of segments includes segment 608 which is a sub-segment of baseline segment 610, as shown in FIG. 6B. An engagement event caused a change in the engagement level and result in the creation of segment 608. For example, a user may be watching a content item with a high engagement level and then without pausing or stopping the content item, mutes the content item, which may indicate that the user is watching the content with a distracted engagement level, and trigger the creation of segment 608 associated with the distracted engagement level that ends at time 1:20. As addressed further below, segments are determined based on calculations of engagement levels and respective thresholds.

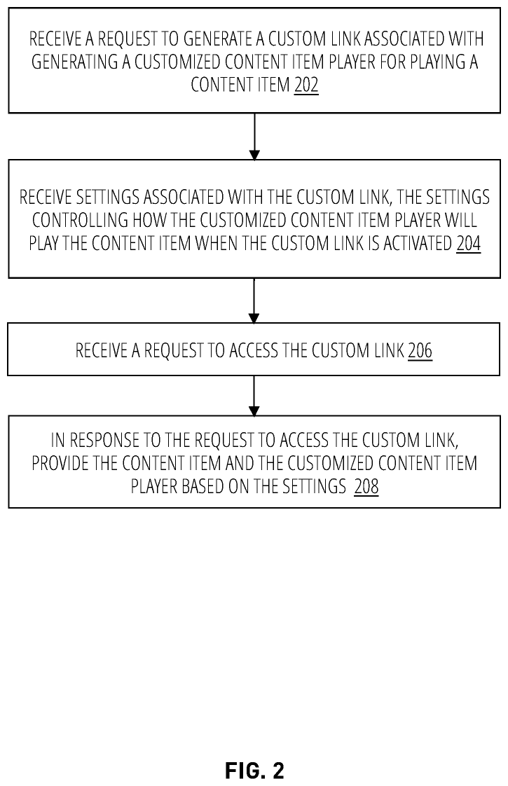

FIG. 2 illustrates example method 200 for generating a custom link associated with a customized content item player dedicated to presenting a content item in accordance with some aspects of the present technology. Although example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements the method 200 may perform functions at substantially the same time or in a specific sequence.

In some cases, it may be desired to have a content item viewed in a specific manner for a specific subset of viewers. For example, for a human resources video that needs to be viewed by a set of employees without an ability to seek forward, a content item player may be customized to play the content item in that specific manner based on configuration settings. The configuration settings may be set when generating a custom link and the content item player may be generated when accessing a custom link. Following the example above, employees may receive a custom link and access the link. When the link is accessed, CLE service 144 or content management system 102, for example, may configure a content item player that is customized to play the content item according to the configurations associated with the custom link.

To start, a request may be made for a custom link for a content item. The request may be made from an interface or a system associated with sharing content items via custom links. In some embodiments, the system can capture engagement data based on how viewers are viewing the content item at respective customized content players associated with the custom links. According to some examples, method 200 includes receiving a request to generate a custom link associated with generating a customized content item player for playing a content item at block 202. In some cases, CLE service 144 or content management system 102 may receive the request to generate the custom link.

According to some examples, the method includes receiving settings associated with the custom link at block 204. The settings may control configurations for how the customized content item player will play the content item when the custom link is activated. In some cases, CLE service 144 or content management system 102 may receive the settings associated with the custom link.

In some cases, the settings may include any type of access settings, such as a password requirement associated with the custom link, an authentication requirement to access the custom link and/or the content item associated with the custom link, or limited access for one or more emails or user accounts to access the custom link, for example.

In some cases, the settings may include settings related to the content item viewing experience once the custom link is accessed. Some examples include an ability to download the content item, an expiration date associated with the custom link, or a digital signature requirement that indicates agreement to a custom contract associated with viewing the content item. For example, some content items may include proprietary information and may require that viewers sign a non-disclosure agreement first.

In some cases, the settings include settings related to the look and feel of presenting the customized content item player. Some examples include providing a customized user interface of the window displaying the customized content item player that is custom to the custom link or providing a custom watermark on the content item that is custom to the custom link.

In some cases, the settings may include settings to configure how the customized content item player operates. For example, the settings may include a setting to automatically play the content item when the custom link is accessed, pause the content item whenever a window displaying the customized content item player is a background window or an inactive window, pause the playing of the content item when the customized content item player is muted, disable a change to a playback speed, or disable forward seeking. In some cases, the settings may cause the customized content item player to present a call to action at a particular part of the content item that requires some form of input or response. As an example, the call to action may be a quiz, an input field, or a link to another webpage that requires further attention.

In some cases, once a custom link such as a unique URL is generated, settings are associated with the custom link. The settings may be Boolean flags that are associated with the custom link in a database. When the custom link is accessed, the associated identifier for the content item and Boolean flags are used to access and set up the customized content item player based on the settings.

According to some examples, the method includes receiving a request to access the custom link at block 206. According to some examples, the method includes providing the content item and the customized content item player that operates based on the settings in response to the request to access the custom link at block 208. The content item may be a video, an audio file, a digital presentation, a digital document, or any other kind of file. In some cases, CLE service 144 may receive the request and provide the content item and the customized content item player based on the settings. The content item and the customized content item player may be generated in a browser window, for example.

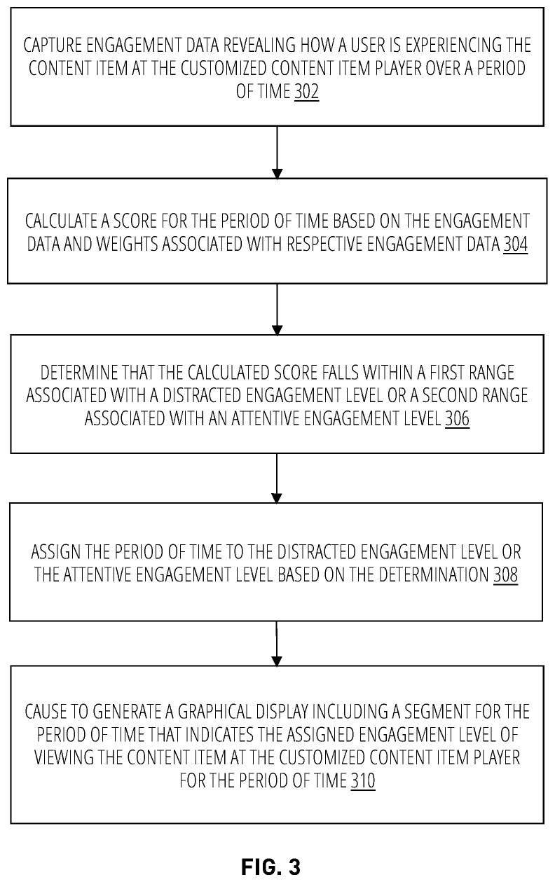

FIG. 3 illustrates example method 300 for assigning an engagement level associated with how engaged a viewer is in viewing the content item during a period of time of viewing of the content item in accordance with some aspects of the present technology. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, method 300 includes capturing engagement data revealing how a user is experiencing the content item at the customized content item player over a period of time at block 302. Engagement data may include any type of data associated with metrics that distinguish different types of engagement associated with how the user is experiencing the content item at the customized content item player. In other words, the engagement data include a state of play of how a user is engaging with the customized content item player. For example, the engagement data may include how the content item is played at the customized content item player at any given moment, such as with sound, muted, player in foreground, player in background, playback speed, forward scrubbing control engagement, and/or backward scrubbing control engagement. The engagement data can be captured by CLE service 144 or content management system 102. The period of time may be a session or part of a session. The session is a period of time starting from when a customized content item player is launched in an application through the custom link to when the application is closed.

The engagement data may also include engagement events. In some cases, changes in the engagement data may be stored as engagement events, which may be used to calculate whether there has been a change in engagement levels (e.g., highly engaged, engaged, distracted, and non-attentive). In some cases, the baseline segment may include one or more sub-segments respectively associated with a block of time and a different engagement level compared to neighboring segments. In some examples, for a given session or a given baseline segment, the engagement level may change between a distracted engagement level and an attentive engagement level. In some cases, a distracted engagement level may indicate that a user is distracted. For example, a distracted user engagement level may be associated with the user placing a window displaying the customized content item player in the background or muting the customized content item player while the content item is playing. On the other hand, an attentive engagement level may not require the highest degree of engagement but merely higher than a set threshold.

According to some examples, method 300 includes calculating a score for the period of time based on the engagement data and weights associated with respective engagement data at block 304. In some cases, CLE service 144 may calculate the score and in some cases, the score may be out of 100. In some cases, the score may be calculated to determine the user's engagement level for a segment. Engagement events may be used to calculate the score and/or a change in the score. User engagement level can be a determination made about how attentive the user is while playing the content item, e.g., the user is highly engaged, engaged, distracted, or non-attentive. In other words, the user engagement level can be determined from a total score calculated from respective engagement data. As such, the engagement data is analyzed to generated engagement analytics such as the determined user engagement level.

In some cases, when there is an engagement event, for example, whether the content item has been changed to being viewed in full screen, has been muted or has been changed to play with volume, has been brought in focus or out of focus, or has been changed to view with a default or altered speed, a total score is calculated again to determine if the total score amounts to a change in engagement level. The engagement events can each be associated with a sub-score and a weight, and the engagement score may be a sum of weighted sub-scores.

For example, when the content item starts to play, how the customized content item player is playing the content item may be logged as a set of engagement events to start. For example, the customized content item player may start by being in focus (associated with a weight of 400 points), playing at full volume (associated with a weight of 400 points whereas playing at 50% volume may be associated with a weight of 200 points), playing the content item on a full screen (associated with a weight of 100 points), and with 100% playback speed (associated with a weight of 100 points whereas % of content item played at 0.5-1.25× is one point and each % played at 1.5-2× is 0 points). The total amount may be summed and divided by 10. In this example, the total may be 100/100. Then, when an engagement event indicates that the user has brought the customized content item player out of focus, the new total amount is reduced to 60/100.

In some embodiments the weights can vary based on configurations associated with the custom link. For example, if the settings for the custom link indicate that volume cannot be changed, the weights associated with a volume level is not relevant since there is not an option to change the volume, and other weights may be shifted as a result as well.

According to some examples, method 300 includes determining that the calculated score falls within a first range associated with a distracted engagement level or a second range associated with an attentive engagement level based on the calculated engagement data at block 306. According to some examples, method 300 includes assigning the period of time to the distracted engagement level or the attentive engagement level based on the determination at block 308. In some cases, CLE service 144 may assign the period of time to the distracted engagement level or the attentive engagement level. According to some examples, different engagement data for segments may be associated with the different engagement levels. In some cases, there may be more than two engagement levels. For example, the engagement levels may range from highly attentive, attentive, distracted, and non-attentive. In some cases, there may be a sliding scale associated with the engagement levels.

In some cases, the different engagement levels may be associated with different colors, shapes, patterns, etc. For example, there may be a “highly engaged” level associated with a first color (e.g. blue) and a score of 91-100 and may be achievable by having 100% audible, 100% viewable, playback speed of 1×, and fullscreen. An “engaged” level may be associated with a second color (e.g. green) and a score of 71-90, which may be generally achievable by having more than 75% viewable and audible. A “distracted” engagement level may be associated with a third color (e.g. yellow) and a score of 31-70 and may be achievable by having between 25% and 75% viewable and audible. A “non-attentive” engagement level may be associated with a fourth color (e.g. red) and score of 0-30 and may be achievable by having generally less than 25% viewable and audible. A “no signal” engagement level may be associated with a fifth color (e.g. grey) and based on visits with no engagement signals (e.g., visits prior to engagement logging launch). Different colors, patterns, or shapes and level requirements may be used for assigning engagement levels of the viewer.

According to some examples, method 300 includes causing to generate a graphical display including a segment that indicates the assigned engagement level of viewing the content item at the customized content item player for the period of time at block 310. The assignment of the period of time to the distracted engagement level or the attentive engagement level effectively creates the respective segment that is generated in the graphical display. In some cases, CLE service 144 may cause to generate the graphical display including different other segments over a longer period of time of a first session.

The graphical display may also include segments associated with a second session, which may be associated with the same user playing the content item through the same customized content item player, a same user playing the content item through a newly generated customized content item player generated from the same custom link, or another user playing the content item through a newly generated customized content item player generated from the same custom link. The second session may be associated with a different browser session and/or at a different device, for example. In addition, the graphical display may also include a third session of the user playing the content item through another customized content item player associated with another custom link.

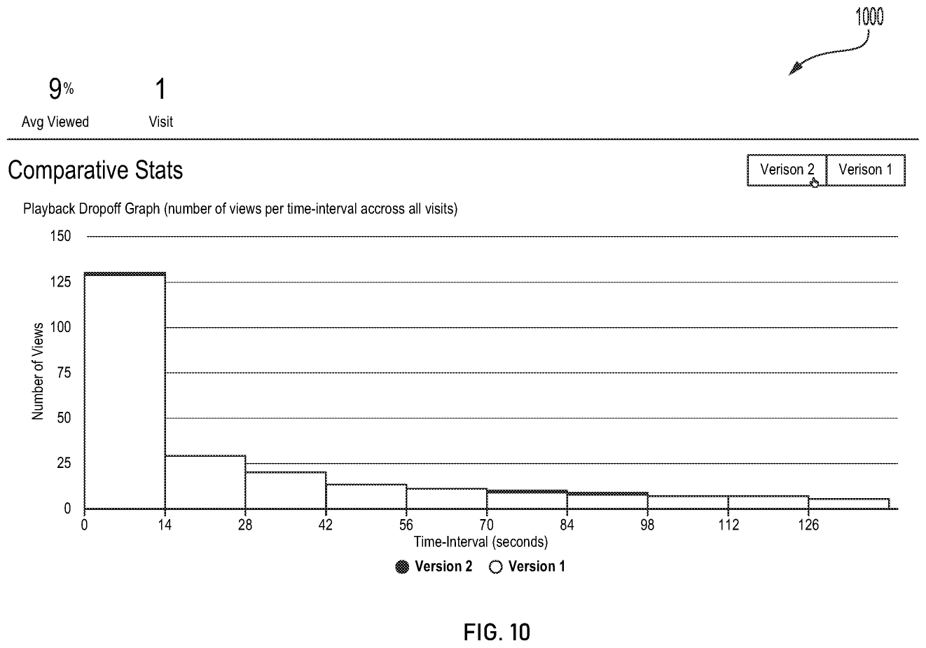

The sessions may be recorded separately. However, the data may be used to summarize aggregated engagement levels from the different sessions. For example, a graphical display of a summary of the engagement levels of playing the content item through the customized content item player or all customized content item players is also generated. The graphical display may include a graph that distinguishes a number of views per different lengths of total playback time and distinguishes between different versions of the content item and different configurations of the customized content item player. An example of such a graphical display is shown in FIG. 10.

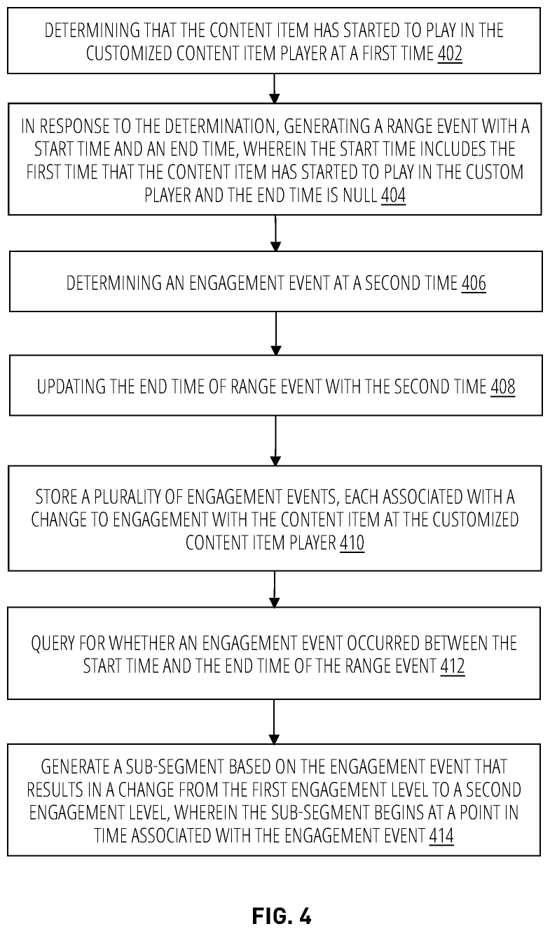

FIG. 4 illustrates an example method 400 for generating segments that visualize the engagement level for segments of viewing in accordance with some aspects of the present technology. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

In order to generate segments illustrating how users are viewing the content item, engagement events are captured and may be used to generate the segments that are visual interpretations of the respective engagement level for each respective period of time. An engagement event may first be recorded with a respective timestamp when there is a state change of how the content item is being experienced at the customized content item player. For example, when the user mutes the customized content item player, the engagement event may be recorded with a respective timestamp. However, if each engagement event is stored as a separate entry, this may not be the most efficient way of storing the data. In some cases, some engagement events can be stored more efficiently in association with a range event, as previously mentioned. The range event refers to a user continuously (e.g., without interruption) playing a content item over a particular time range defined by a start time and an end time. The range event defines a start time of when the content item has started to play, but since the end time is initially unknown, the end time is later updated. The range event creates a baseline segment and other engagement events may be used to generate other sub-segments.

According to some examples, the method includes determining that the content item has started to play in the customized content item player at block 402. In some cases, CLE service 144 may determine that the content item has started to play in the customized content item player. In some cases, CLE service 144 may generate the baseline segment. According to some examples, the method includes generating a range event with a start time and an end time in response to the determination at block 404. The content item may have been determined to have started to play in the customized content item player at a first time and the start time may be set as the first time and the end time may be set as null.

According to some examples, the method includes determining an engagement event has occurred at a second time at block 406. The engagement event includes the content item being paused, stopped, or seeked back, for example. CLE service 144 may update the end time of the range event with the second time at block 408, and the range event is used to generate a baseline segment with a first engagement level. By updating the end time, an event stream is stored in a more efficient and streamlined manner.

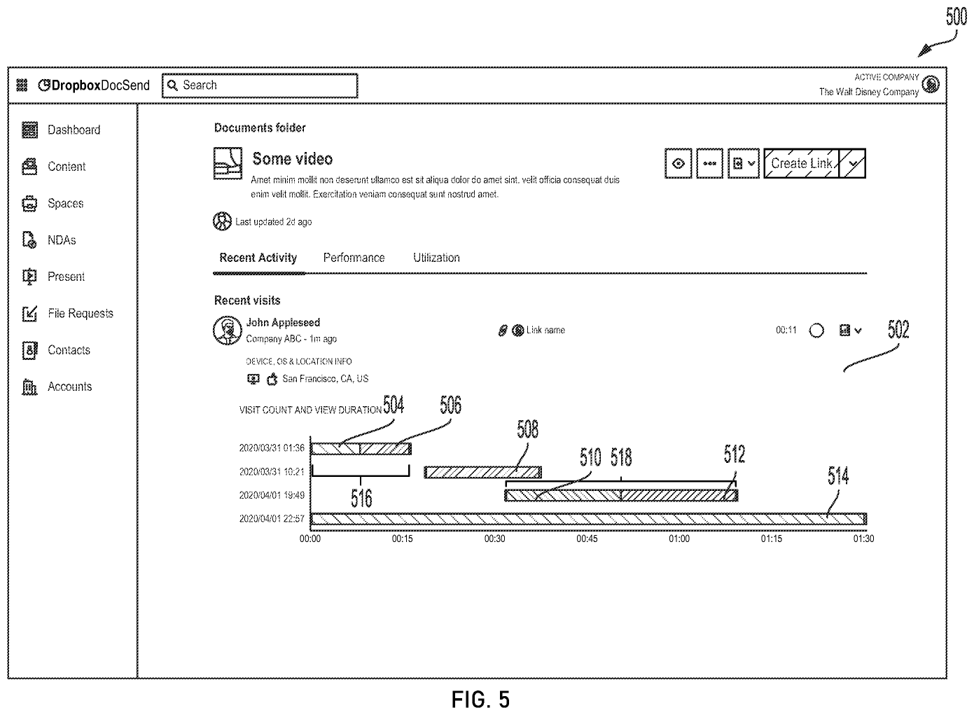

In some cases, an interface, such as those shown in FIG. 5, FIG. 6A, and FIG. 6B, may display the various segments illustrating how the content item is viewed. In some cases, when the content item is paused and then played again, a second segment that is separated by some space from a first segment (associated with time that has passed) may appear within a similar row. The first segment represents when the user watched and then paused the customized content item player and the second segment represents when the user has played the content item again. In other cases, when the content item is seeked back, the second segment may appear in a different row so that the segments do not overlap one another in the same row.

According to some examples, the method includes storing a plurality of engagement events, each associated with a change to the engagement with the content item at the customized content item player at block 410. In some cases, CLE service 144 may store the plurality of engagement events each associated with a change to the engagement with the content item. For example, during the playing of the content item, the user may change how they are viewing the content item. For example, the user may change engagement with the content item such as changing the playback speed or muting the customized content item player. According to some examples, the method includes querying for whether an engagement event occurred between the start time and the end time of the baseline segment at block 412.

According to some examples, the method includes generating a sub-segment based on the engagement event that results in a change from the first engagement level associated with the creation of the baseline segment to a second engagement level at block 414. The sub-segment may start at a time associated with when the engagement event starts and ends when another engagement event results in a change to the engagement level, or at the end time of the baseline segment. For example, from 0.0 seconds to 2.5 seconds the viewer was viewing the content item at an attentive engagement level and at 2.5 seconds, the viewer decided to mute the customized content item player. If this changes the engagement level from the attentive engagement level to a distracted engagement level, a sub-segment is generated starting at 2.5 seconds.

In some cases, real-time updates are presented at the graphical display. In some cases, real-time updates may include the dynamic creation of a new baseline segment in response to a start of playing of the content item or a new sub-segment in response to an engagement event that changes the engagement level from a neighboring sub-segment. In some cases, the segment may expand in real-time as the content item is being experienced in the customized content item player. Then, when an engagement event changes the engagement level during playing of the content item, a sub-segment with different display characteristics may be populated in real-time as the content item is being viewed in the customized content item player. For example, a new sub-segment with the different display characteristic may be displayed in real-time as the content item is being viewed in the customized content item player when an engagement event changes the engagement level. In some cases, a different display characteristic may be set for segments associated with the distracted engagement level and segments associated with the attentive engagement level. As such, the segment may have a different display characteristic from the rest of the baseline segment.

FIG. 5 illustrates example graphical display 500 showing segments associated with a session for a custom link of a first content item in accordance with some aspects of the present technology.

Graphical display 500 depicts recent visits by one or more viewers. A set of engagement analytics is associated with a device and an associated user. The set of engagement analytics as depicted in graphical display 500 distinguishes between segment 504, segment 506, segment 508, and segment 510, segment 512, and segment 514 for session 502 associated with a period of time that a customized content item player is launched in an application through engagement of the custom link. The segments are displayed along a horizontal axis indicating time within a length of time of the content item (e.g., 0.15 seconds into the content of the content item). In addition, segment 504 and segment 506 together forms segment 516 and segment 510 and segment 512 form segment 518. Segment 516 and segment 518 may each be associated with a range event, referring to a user continuously (e.g., without interruption) playing a content item over a particular time range defined by a start time and an end time. In addition, segment 508 and segment 514 alone may be associated with a range event.

In some cases, when a player seeks back or a threshold period of time has passed, a new row may be generated for one or more new play events that occur after the seeking back. In some cases, each row is associated with one or more segments, such as bar segments. The segments may be associated with different rows, which are used as a way to display the engagement level in a more effective way such that there are no overlapping segments. In some examples, segments in a single session may be grouped together so a visual representation of how a user experienced the content item is readily apparent. Examples of different segments of example engagement levels are shown in FIG. 5 to FIG. 6B.

As mentioned previously, the segments may be associated with different rows, which are used as a way to display the segments in a more effective way such that there are no overlapping segments. The segment 504 starts at time 0.0 seconds of the content item and continues until around 7.5.0 seconds of the content item. The segment 504 is represented by a first color (e.g., green) associated with an “engaged” state. Segment 506 begins at around 7.5 seconds into the content item and ends at around 15.0 seconds into the content item and is represented in a second color (e.g., blue) associated with a “highly engaged” state. In segment 508, display characteristics are provided in the second color (e.g., blue) associated with a “highly engaged” engagement level. The segment 508 starts at time 16 seconds into the content item and continues until around 40.0 seconds into the content item. Therefore, in segment 508, the user played the content item and their engagement level was determined to be in an “highly engaged” state.

The user seeks back to the 30.0 second mark and segment 510 starts at time 30.0 seconds into the content item and continues until around 50 seconds into the content item. The segment 510 is in a third color (e.g., yellow) associated with a “distracted” state. Segment 512 is in a fourth color (e.g., red) associated with an “ignored” state, begins at around 50.0 seconds into the content item and ends at around 1 minute and 10.0 seconds into the content item. The user then seeks back again to time 0 seconds this time and segment 514, associated display characteristics include the first color (e.g., green) associated with “engaged”, starts at time 0 seconds into the content item and continues until around 1 minute and 30.0 seconds into the content item. Therefore, for segment 510, the viewer watched the content item in an “engaged” state. As such, session 502 includes four range events and six segments associated with distinct engagement levels.

FIG. 6A illustrates an example graphical display 600a showing segments associated with a session for viewing a content item after a first period of time in accordance with some aspects of the present technology. Engagement analytics are depicted for a first viewer. Engagement analytics for second viewer 604 and third viewer 606 may viewed by expanding their respective sections. The engagement analytics may be displayed in real-time. At a first time, the first viewer is watching at a 1 minute mark in the content item 602 as shown in segment 608 and is watching in an “ignored” state, with a window displaying a customized content item player playing content item 602.

In some cases, a selection of one of the segments may be received. In response, CLE service 144 may cause to display at least one detail related to the engagement analytics for the respective segment, such as which engagement analytics were associated with how the content item was played. In some cases, the at least one detail may be a preview or clip of the content item at a respective time or time segment, or may include text about the at least one detail in a detail card, such as detail card 612.

FIG. 6B illustrates an example graphical display 600b showing segments associated with the session for the content item after a second period of time in accordance with some aspects of the present technology. With the engagement analytics displayed in real-time, at a second time, the viewer has stopped watching at a 1 minute and 35.0 second mark into the content item and changed from the “ignored” state to a “distracted” state. Segment 608 was expanding in real-time and segment 610 gets populated when the engagement level changes from the “ignored” state to a “distracted” state.

There may be engagement analytics 614 that indicate a summary of how engaged the viewer was. There may be completion analytics 616 that indicate what percentage of the entire content item was viewed by the viewer. There may be an indication of total time 618 that was spent in a particular session.

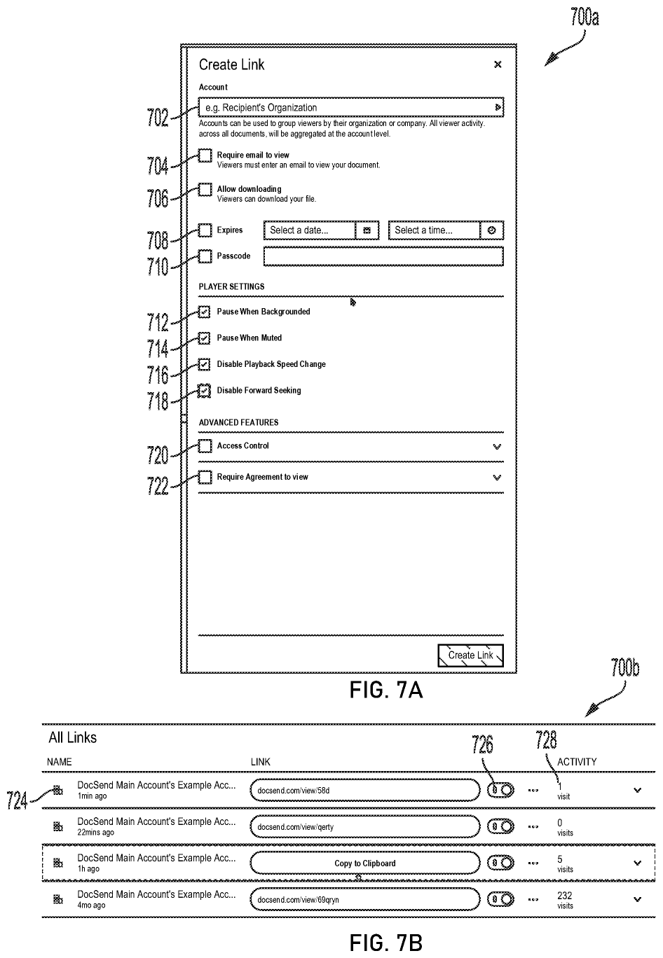

FIG. 7A illustrates an example settings configuration panel 700a that includes various options for configuring a custom link for viewing a content item in accordance with some aspects of the present technology.

Settings configuration panel 700a may include options such as account field option 702 that allows content items to be grouped for a particular organization or company, such that all viewer activity across all content items may be aggregated for an administrator account. Settings configuration panel 700a may include email requirement option 704. Settings configuration panel 700a may include allow downloading option 706 that permits viewers to download the content item.

Settings configuration panel 700a may include expiration option 708 that sets an expiration date and time associated with the custom link. The settings configuration panel 700a may include passcode option 710 that requires a passcode to access the custom link. Settings configuration panel 700a may include player settings such as pause when backgrounded option 712, pause when muted option 714, disable playback speed change option 716, and/or disable forward seeking option 718.

Settings configuration panel 700a may include access control options 720 that may be further configured. For example, there may be restrict control as to which visitors are allowed to view the content item. In response to providing an email, there may be an authentication process that is required. Settings configuration panel 700a may include require agreement option 722 that requires that viewers enter their name and email and agree to an agreement (e.g., a non-disclosure agreement) before viewing the content item. Furthermore, more advanced customizations may be included, such as setting rules regarding call to action items that may be integrated with the playback of the content item.

In some cases, CLE service 144 may provide calls to action based on a determined user segment. For example, a user may configure a setting that is associated with providing one or more actions in response to determining an engagement level. The call to action may be activated when a certain user engagement level is exhibited within a baseline segment. For example, a pop-up may appear if the engagement level is lowered. The pop-up may ask a question about what has been presented or a code that was revealed while the content item was playing. In addition, other applications may be integrated through an API and for example, a request to schedule a meeting that is linked to a scheduling application may appear when the engagement level is heightened.

FIG. 7B illustrates example graphical display 700b of a list of generated custom links associated with a content item in accordance with some aspects of the present technology. For each content item, there may be a plurality of different custom links. For example, custom link 724 may include toggle option 726 to turn it on and off. Custom link 724 may also include activity data 728. In some cases, the customizations made in settings configuration panel 700a may be further edited after the link is created.

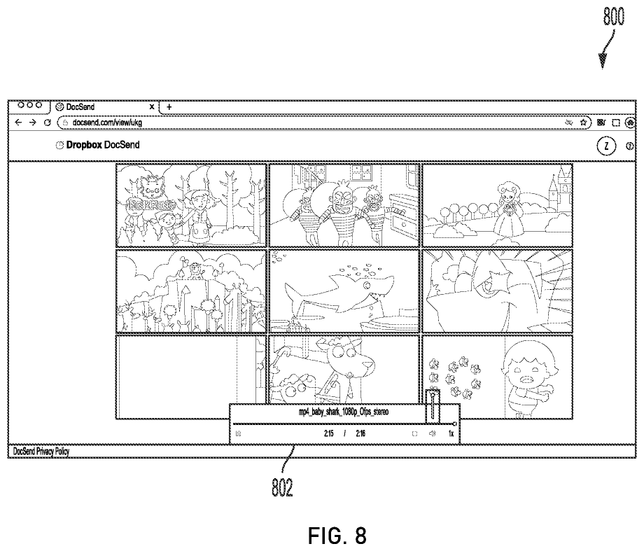

FIG. 8 illustrates example window 800 associated with a custom link and associated customized content item player 802 of a content item in accordance with some aspects of the present technology. While the content item is being viewed on customized content item player 802, engagement data is recorded and sent to CLE service 144.

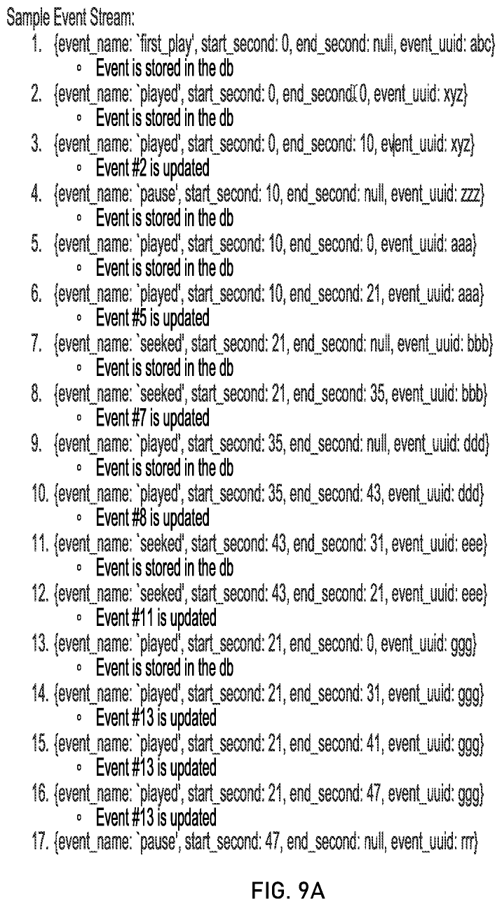

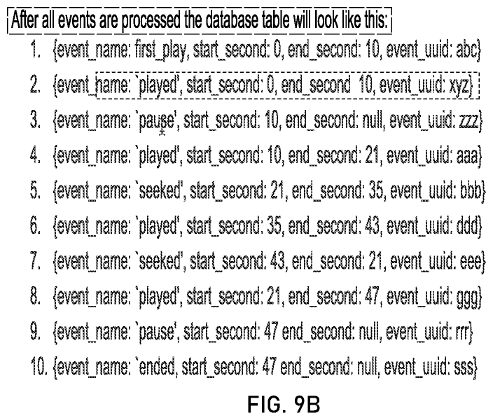

FIG. 9A illustrates an example event stream data associated with events such as when a content item is played, paused, seeked forward, or seeked backwards in accordance with some aspects of the present technology. Each event that is received may either be stored in the database or may update an existing event stored in the database. For baseline segments with a start time and an end time, the start time may include the first time that the content item has started to play in the customized content item player and the end time may be null. Then, when the customized content item player is paused or no longer playing in a same manner at a second time, the end time may be updated with the second time.

FIG. 9B illustrates processed event data in a database table based on processing of the event stream data and has start times and updated end times for relevant events in FIG. 9A in accordance with some aspects of the present technology. Therefore, the stored database table using this technique stores the processed events more efficiently.

FIG. 10 illustrates an example graphical display 1000 of comparative statistics associated with how engaged viewers are in viewing the content item in accordance with some aspects of the present technology. In some cases, the comparative statistics may compare a number of views per a time interval amount of playback across all viewers. Graphical display 1000 illustrates that a little over 125 views are associated with playback amount of 0-14 seconds, and 25 views are associated with a playback amount of 14-28 seconds. The comparative statistics indicate that around half of the viewers are stopping the content item after watching 14 seconds. Other types of comparative statistics may be generated as well. For example, comparative statistics associated with comparing what sections of the content item performed well in terms of engagement.

In some embodiments, the CLE service can provide insights from aggregated data from a plurality of viewers playing the content item. If aggregated user engagement levels indicate that a certain subset of viewers are skipping past a particular section of the content item, for example, the insight may indicate that the subset of viewers should receive a link to a follow-up content item. Insights may be layered on top of the engagement analytics to improve understanding of how to revise the content item to improve engagement levels for users playing the content item. For example, a revised content item may be generated based on analyzed historical engagement levels of a plurality of sessions associated with the content item, and the content item may be replaced with the revised content item based on the analyzed engagement levels. If more than a threshold number of viewers are skipping an unnecessary introduction in the content item, for example, that part may be removed or shortened in a revised content item that is offered as a replacement. Furthermore, a different version of the content item may be used in association with a same custom link. The comparative statistics may then be compared across different versions.

As another separate example, CLE service 144 may provide a recommendation in response to the engagement analytics and certain engagement events. If the engagement analytics indicate that a certain subset of viewers are skipping past a particular section of the content item, for example, the recommendation may indicate that the subset of viewers need a follow up content item. Insights may be layered on top of the engagement analytics to improve understanding of how to revise the content item to improve engagement. For example, a revised content item may be generated based on analyzed historical engagement levels associated with the content item, and the content item may be replaced with the revised content item based on the analyzed engagement levels. If a threshold number of viewers are skipping an unnecessary introduction in the content item, for example, that part may be removed or shortened in a revised content item that is offered as a replacement.

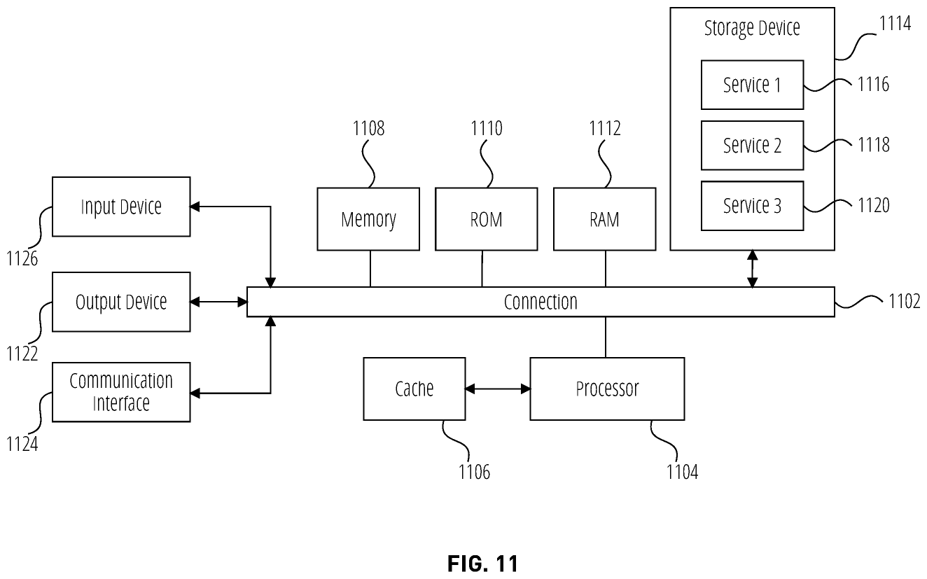

FIG. 11 shows an example of computing system 1100, which can be for example any computing device making up content management system 102 or client devices 134, or any component thereof in which the components of the system are in communication with each other using connection 1102. Connection 1102 can be a physical connection via a bus, or a direct connection into processor 1104, such as in a chipset architecture. Connection 1102 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1100 includes at least one processing unit (CPU or processor) 1104 and connection 1102 that couples various system components including system memory 11088, such as read-only memory (ROM) 1110 and random access memory (RAM) 1112 to processor 1104. Computing system 1100 can include a cache of high-speed memory 1108 connected directly with, in close proximity to, or integrated as part of processor 1104.

Processor 1104 can include any general purpose processor and a hardware service or software service, such as services 1106, 1118, and 1120 stored in storage device 1114, configured to control processor 1104 as well as a special-purpose processor where software instructions are incorporated into the actual processor design. Processor 1104 may essentially be a completely self-contained computing system, containing multiple cores or processors, a bus, memory controller, cache, etc. A multi-core processor may be symmetric or asymmetric.

To enable user interaction, computing system 1100 includes an input device 1126, which can represent any number of input mechanisms, such as a microphone for speech, a touch-sensitive screen for gesture or graphical input, keyboard, mouse, motion input, speech, etc. Computing system 1100 can also include output device 1122, which can be one or more of a number of output mechanisms known to those of skill in the art. In some instances, multimodal systems can enable a user to provide multiple types of input/output to communicate with computing system 1100. Computing system 1100 can include communication interface 1124, which can generally govern and manage the user input and system output. There is no restriction on operating on any particular hardware arrangement, and therefore the basic features here may easily be substituted for improved hardware or firmware arrangements as they are developed.

Storage device 1114 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1114 can include software services, servers, services, etc., that when the code that defines such software is executed by the processor 1104, it causes the system to perform a function. In some embodiments, a hardware service that performs a particular function can include the software component stored in a computer-readable medium in connection with the hardware components, such as processor 1104, connection 1102, output device 1122, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method comprising:
receiving a request to generate a custom link associated with generating a customized content item player for playing a content item;
receiving settings associated with the custom link, the settings controlling how the customized content item player will play the content item when the custom link is activated;
receiving a request to access the custom link; and
in response to the request to access the custom link, providing the content item and the customized content item player based on the settings in a first session.

2. The computer-implemented method of claim 1, further comprising:
receiving engagement data associated with how a user is experiencing the content item at the customized content item player, wherein the engagement data distinguishes between segments associated with respective engagement levels.

3. The computer-implemented method of claim 2, further comprising:
receiving a rule associated with providing one or more customized calls to action in response to a change in the engagement data that results in a change of an engagement level, wherein the rule is set in association with the custom link; and
enabling a respective call to action associated with the change of the engagement level based on the rule.

4. The computer-implemented method of claim 2, further comprising:
providing a recommendation in response to the engagement data, wherein the recommendation includes a revised content item revised based on the engagement data.

5. The computer-implemented method of claim 2, further comprising:
causing to generate a graphical display of a summary of the engagement data of experiencing the content item through the customized content item player, wherein the graphical display includes a graph that distinguishes a number of views per different lengths of total playback time.

6. The computer-implemented method of claim 2 further comprising:
analyzing the engagement data to generate engagement analytics; and
causing to generate a graphical display of the engagement analytics of experiencing the content item through the customized content item player, wherein the graphical display of the engagement data includes the segments associated with respective engagement levels.

7. The computer-implemented method of claim 6, wherein the graphical display includes engagement analytics associated with a second session of experiencing the content item through the customized content item player, or a third session of experiencing the content item through another customized content item player associated with another custom link.

8. The computer-implemented method of claim 6, further comprising:
causing to present real-time updates to the graphical display that dynamically creates a new baseline segment in response to a start of playing of the content item or a new sub-segment in response to a change in engagement level from a neighboring sub-segment.

9. The computer-implemented method of claim 6, wherein analyzing the engagement data further comprising:
calculating a score for a period of time during which the content item is played at the customized content item player based on the engagement data and weights associated with respective engagement data;
determining that the calculated score falls within a first range associated with a distracted engagement level or a second range associated with an attentive engagement level; and
assigning the period of time to the distracted engagement level or the attentive engagement level that based on the determination,
wherein the graphical display includes a segment for the period of time that indicates a respective engagement level of viewing the content item at the customized content item player based on the assigned engagement level.

10. The computer-implemented method of claim 9, wherein the engagement data includes whether the content item is viewed in full screen, whether the content item is muted, whether the content item is played with volume, whether the content item is in focus, or whether the content item is viewed at a particular speed.

11. The computer-implemented method of claim 9, further comprising:
receiving a selection of the segment; and
causing to display a detail associated with how the content item is was experienced or a preview of the content item at a respective time.

12. The computer-implemented method of claim 1, further comprising:
determining that the content item has started to play in the customized content item player at a first time;
in response to the determination, generating a range event with a start time and an end time, wherein the start time includes the first time that the content item has started to play in the customized content item player and the end time is null;
determining that the content item is paused or no longer playing in a same manner at a second time; and
updating the end time of the range event with the second time, wherein the range event is associated with a baseline segment with a first engagement level.

13. The computer-implemented method of claim 12, further comprising:
storing a plurality of engagement events each associated with the content item at the customized content item player, wherein the baseline segment is associated with a set of engagement data;
querying for whether an engagement event occurred between the start time and the end time of the baseline segment; and
generating a sub-segment based on the engagement event that results in a change from the first engagement level to a second engagement level.

14. The computer-implemented method of claim 13, further comprising:
causing to display the baseline segment and the sub-segment expanding in real-time as the content item is being experienced in the customized content item player; and
causing to display, in real-time, a new sub-segment with a different display characteristic in real-time as the content item is being experienced in the customized content item player when engagement changes from the second engagement level to a third engagement level.

15. The computer-implemented method of claim 9, further comprising:
providing a first set of display characteristics for segments associated with the distracted engagement level and a second set of display characteristics for segments associated with the attentive engagement level.

16. A system comprising:
at least one processor; and
a memory storing instructions that, when executed by the at least one processor, configure the system to:
receive a request to generate a custom link associated with generating a customized content item player for playing a content item;
receive settings associated with the custom link, the settings controlling how the customized content item player will play the content item when the custom link is activated;
receive a request to access the custom link;
in response to the request to access the custom link, provide the content item and the customized content item player based on the settings in a first session;
receive engagement data associated with how a user is experiencing the content item at the customized content item player; and
analyze the engagement data to generate engagement analytics, wherein the engagement analytics distinguishes between segments associated with a period of time with respective engagement levels.

17. The system of claim 16, wherein the instructions further configure the system to:
cause to generate a graphical display of the engagement analytics of viewing the content item through the customized content item player; and
cause to present real-time updates to the graphical display that dynamically creates a new segment in response to a start of playing of the content item or a new sub-segment in response to a change in engagement level from a neighboring segment.

18. The system of claim 16, wherein the instructions further configure the system to:
calculate a score for a period of time during which the content item is played at the customized content item player based on the engagement data and weights associated with respective engagement data;
determine that the calculated score falls within a first range associated with a distracted engagement level or a second range associated with an attentive engagement level;
assign the period of time to the distracted engagement level or the attentive engagement level that based on the determination; and
cause to generate a graphical display including a segment for the period of time that indicates a respective engagement level of viewing the content item at the customized content item player based on the assigned engagement level.

19. A non-transitory computer-readable storage medium including instructions that when executed by a computer, cause the computer to:
receive settings associated with generating a custom link, the settings controlling how a customized content item player will play a content item when the custom link is activated;
receive a request to access the custom link;
in response to the request to access the custom link, provide the content item and the customized content item player based on the settings in a first session;
receive engagement data revealing how a user is experiencing the content item at the customized content item player over a period of time;
calculate a score for the period of time based on the engagement data and weights associated with respective engagement data;
determine that the calculated score falls within a first range associated with a distracted engagement level or a second range associated with an attentive engagement level;
assign the period of time to the distracted engagement level or the attentive engagement level that based on the determination; and
cause to generate a graphical display including a segment for the period of time that indicates a respective engagement level of viewing the content item at the customized content item player based on the assigned engagement level.

20. The non-transitory computer-readable storage medium of claim 19, wherein the instructions further cause the computer to:
cause to present real-time updates to the graphical display that dynamically creates a new segment in response to a start of playing of the content item or a new sub-segment in response to a change in engagement level from the respective engagement level of the segment.
